(19) United States
(12) Patent Application Publication
(10) Pub. No.: US 2005/0165746 A1
(43) Pub. Date: Jul. 28, 2005

(54) System, apparatus and method of pre-fetching data

(75) Inventors: Vijaylaxmi Chakravarty, Austin, TX (US); Oltea Mihaela Herescu, Austin, TX (US); Claudia Andrea Salzberg, Austin, TX (US); Robert Lee Snider, Cedar Park, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/756,132

(22) Filed: Jan. 13, 2004

(51) Int. Cl. G06F 17/30

(52) U.S. Cl. 707/3

(57) ABSTRACT

A system, apparatus and method of pre-fetching data are provided. When a first piece of information is being displayed to a user, the system, apparatus and method determine whether a second piece of information is data-intensive. If the second piece of information is data-intensive, it is pre-fetched into a cache. To implement the invention, however, the application program used to display the information to the user is first parsed for embedded database query calls. If the application program provides the information to the user in a number of succeeding panels, each piece of code representing a panel will be individually parsed. Each query call is identified as selectable or un-selectable. A selectable query call is a call that is used to fetch a piece of data-intensive information; whereas an un-selectable query call is a call that is used to fetch non-data-intensive information. Each selectable call is entered in its respective panel in a table, which is divided into the same number of panels. This allows the system, apparatus and method to determine whether a second piece of information is data-intensive and thus pre-fetch the data for caching.

### BACKGROUND OF THE INVENTION

1. Technical Field

The present invention is directed to database systems. More specifically, the present invention is directed to a system, apparatus and method of pre-fetching data from a database system.

2. Description of Related Art

Many application programs require access to functions of a relational database to ensure efficient management and availability of data. As a result, application program source code often contains embedded query language statements to interface with a relational database. The statements may include commands to fetch data that is to be provided to a user. In some instances, it may be desirable to pre-fetch and store particular pieces of data into a cache in order to lessen the time it would ordinarily require to provide the data to the user. For example, an image file, which is data-intensive, may be pre-fetched into the cache.

However, unless a piece of data is likely to be provided to the user, it may be counter-productive to pre-fetch the data. Thus, what is needed is a system, apparatus and method of determining data that is likely to be provided to the user such that it can be pre-fetched.

### SUMMARY OF THE INVENTION

The present invention provides a system, apparatus and method of pre-fetching data. When a first piece of information is being displayed to a user, the system, apparatus and method determine whether a second piece of information is data-intensive and likely to be accessed. If so, it is pre-fetched into a cache. Consequently, if the user decides to access to the second piece of information, it will be provided in a relatively short time.

To implement the invention, however, the application program used to display the information to the user is first parsed for embedded database query calls. If the application program provides the information to the user in a number of succeeding panels, each piece of code representing a panel will be individually parsed. Each query call is identified as selectable or un-selectable. A selectable query call is a call that is used to fetch a piece of data-intensive information; whereas an un-selectable query call is a call that is used to fetch non-data-intensive information. Each selectable call is entered in its respective panel in a table, which is divided into the same number of panels. This allows the system, apparatus and method to determine whether a second piece of information is data-intensive and likely to be accessed and thus to pre-fetch it into a cache.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4(a) depicts a conceptual view of an application program that may be used to access a Web site.

FIG. 4(b) depicts a conceptual view of an application program with data pre-fetching that may be used to access a Web site.

FIGS. 4(c), 4(d) and 4(e) depict steps that may be used by a developer to implement the invention.

FIG. 5 is a flowchart of a process that may be used to implement the invention.

FIG. 6 depicts an exemplary table that may be used by the invention.

FIG. 7 is a flowchart of a process that may be used when a user accesses a Web site.

### DETAILED DESCRIPTION OF THE PREFERRED EMBODIMENT

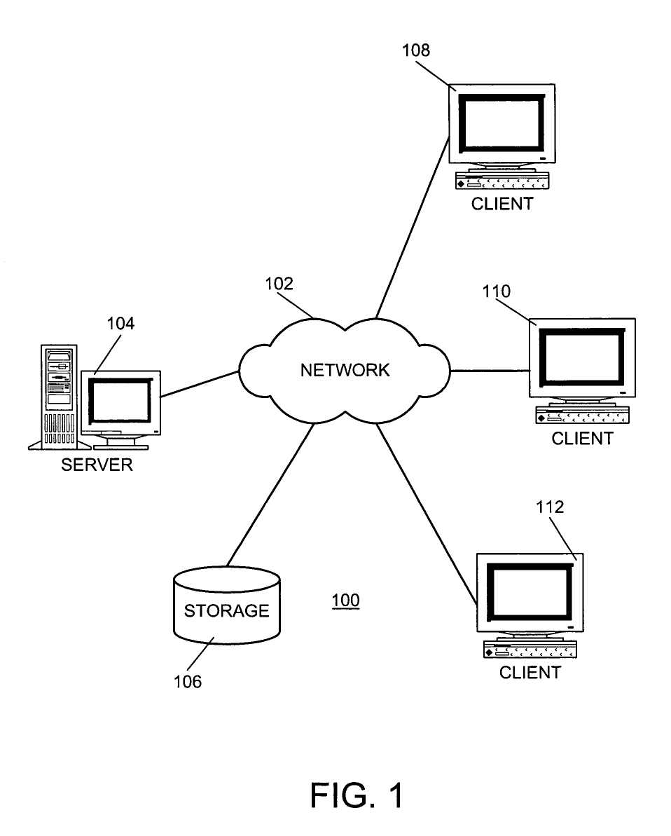

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

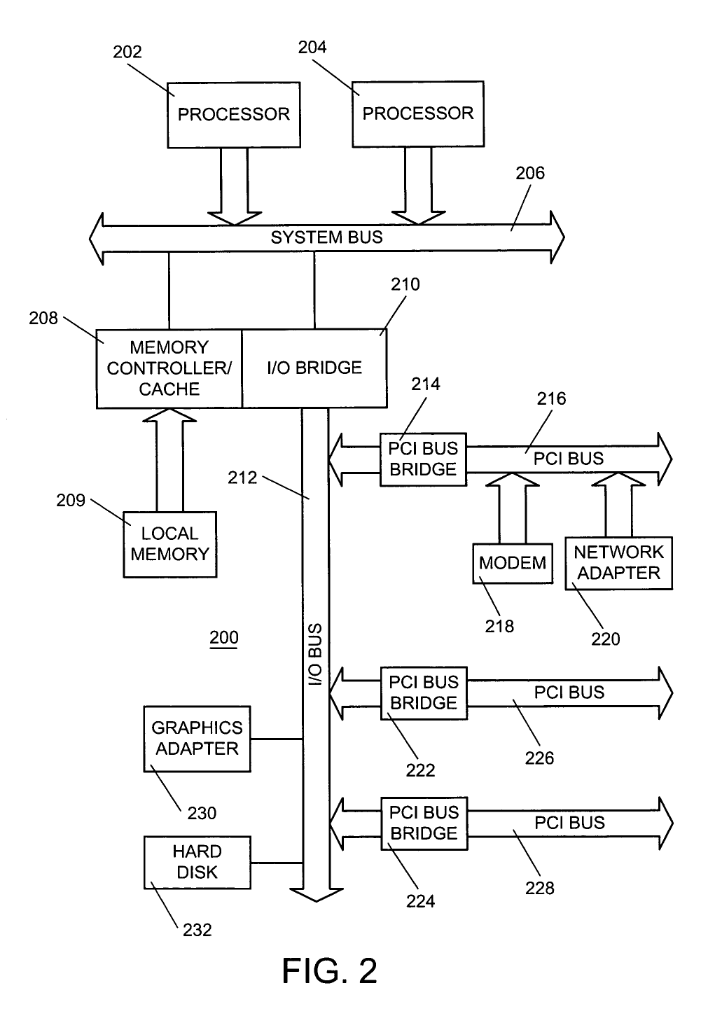

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

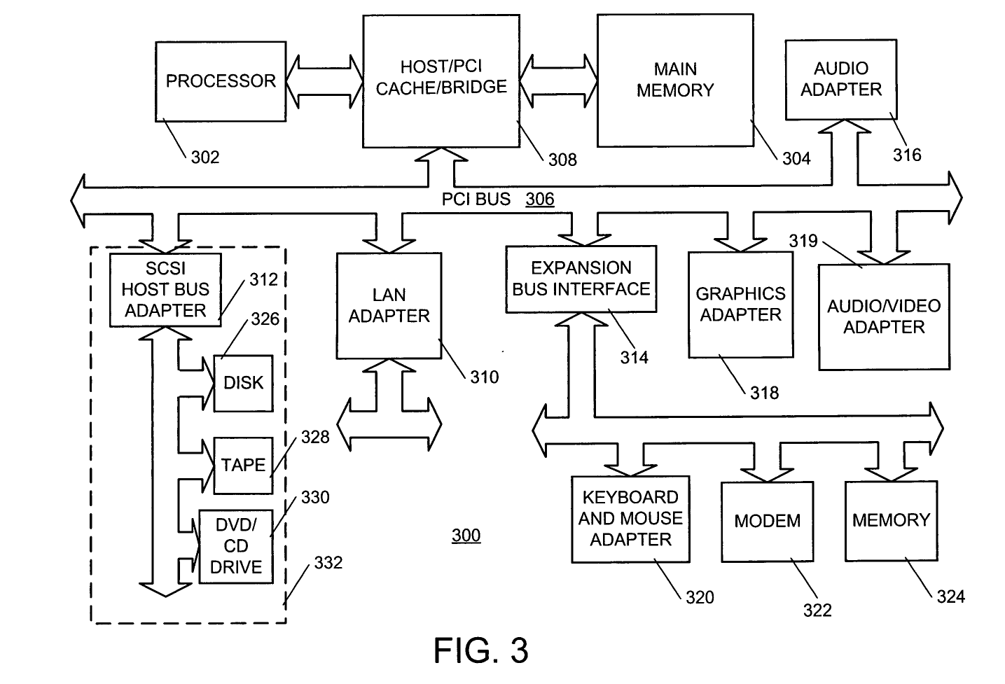

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM/DVD drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP™, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides a system, apparatus and method of determining data to pre-fetch. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

Java Database Connectivity (JDBC) is a Java application program interface (API) that enables Java programs to execute Structured Query Language (SQL) statements. (SQL is a standardized query language for requesting information from a database.) This allows Java programs to interact with any SQL-compliant database. Since nearly all relational database management systems (DBMSs) support SQL, and because Java runs on most platforms, JDBC makes it possible to write a single database application that can run on different platforms and interact with different DBMSs.

Further, Open DataBase Connectivity (ODBC) is an API that allows a program to access functions of a database. ODBC makes it possible to access any data from any application, regardless of which DBMS is handling the data. ODBC manages this by inserting a middle layer, a driver, between an application program and the DBMS. The driver translates the application's data queries into commands that the DBMS understands. Thus, OBDC is language-independent. Hence, Java programming may interact as well with ODBC.

Consequently, either JDBC or ODBC may be used with the present invention. Further, the invention will be explained using Java and SQL. However, it should be understood that any other programming language (e.g., C, C++, COBOL, etc.) and any other query language may equally be used. Thus, the use of Java and SQL is for illustration purposes only.

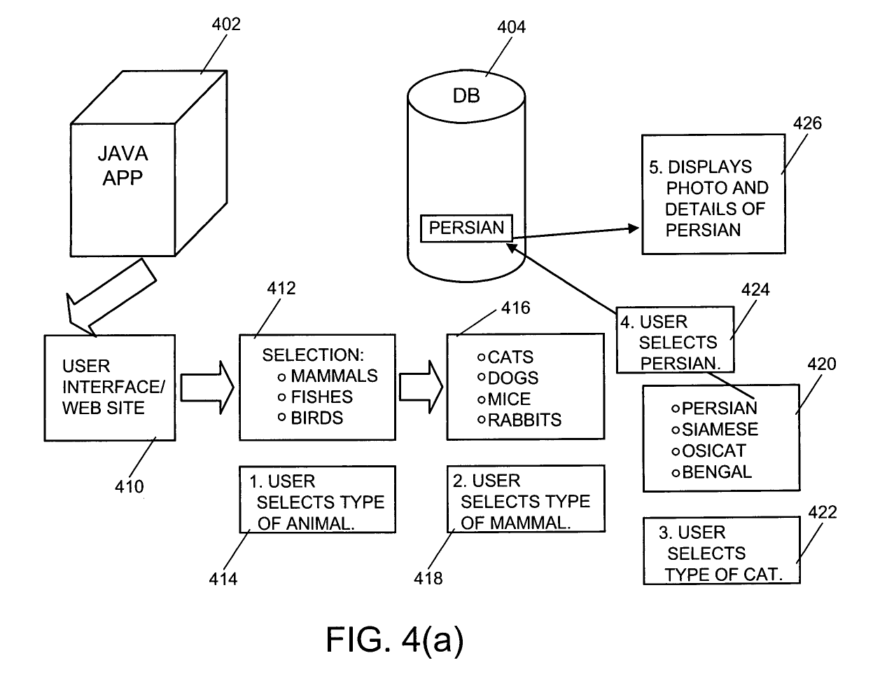

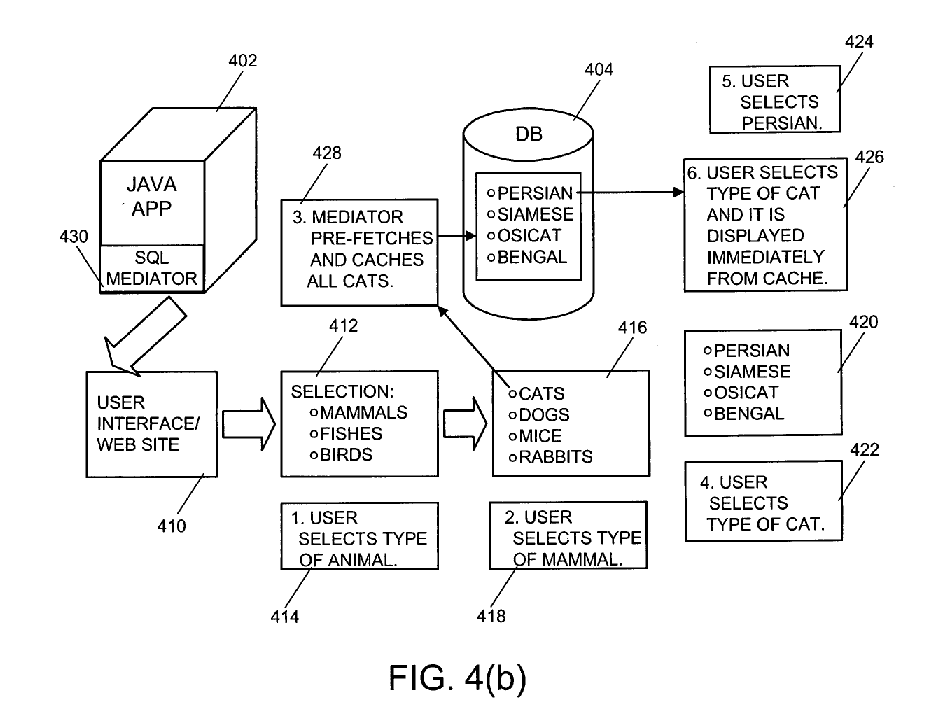

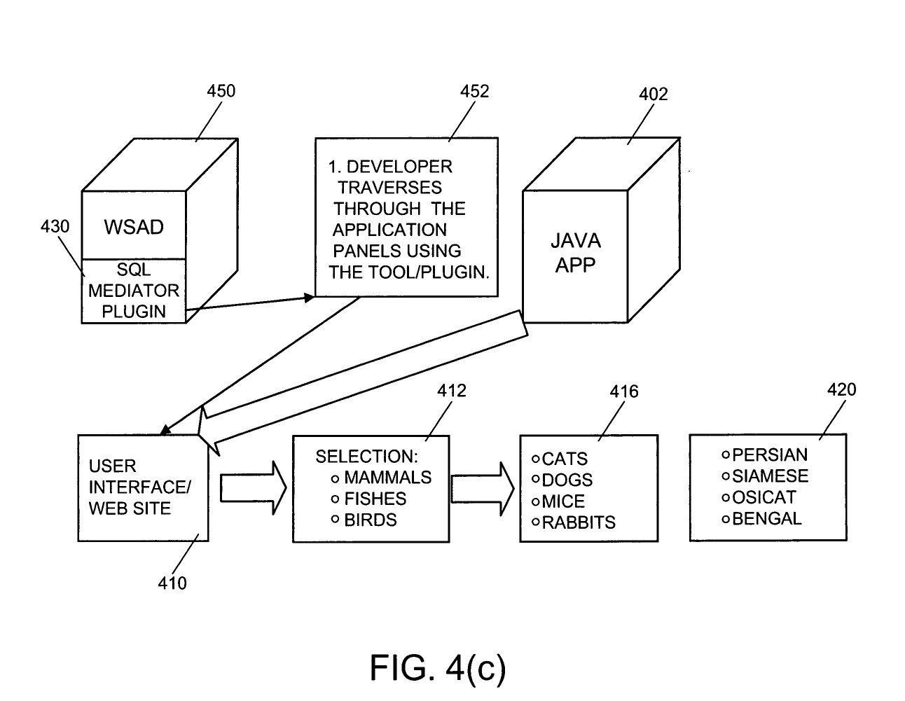

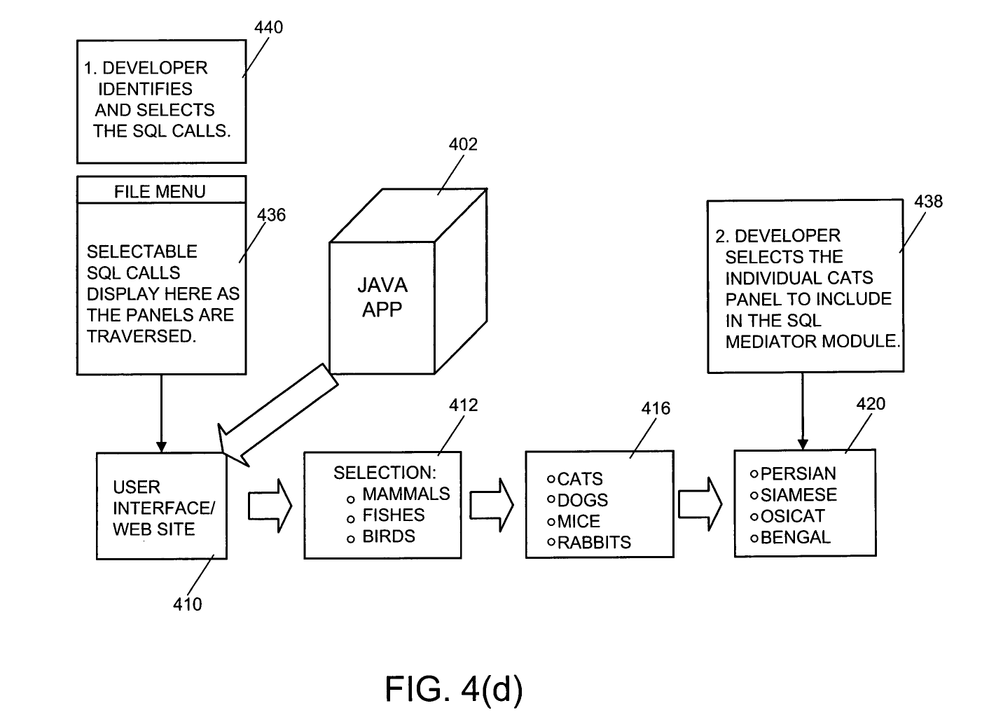

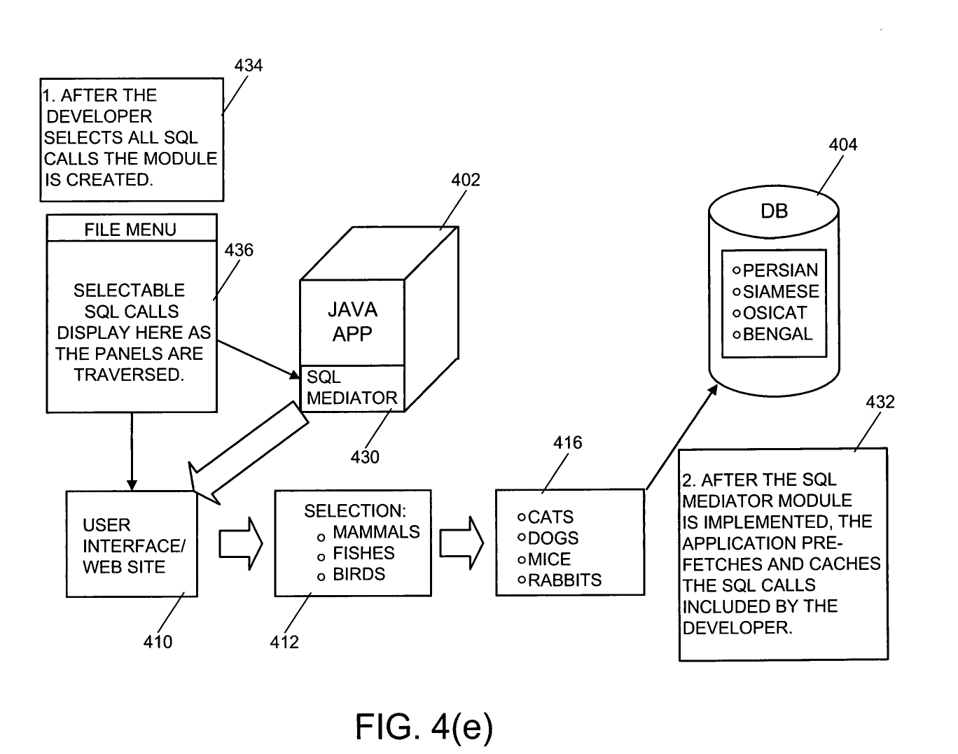

FIG. 4(a) depicts a conceptual view of an application program that may be used to access a Web site. The Web site is of a Pet Shop and the application program allows a Web user to access data from the Web site. The Web site may be located on server 104 and the user may be using any one of client systems 108, 110 and 112 to access the Web site. When the user accesses the Pet Shop Web site, Java application 402 may be downloaded to the client system being used by the user for execution. Alternatively, Java application 402 may be executed on the server 104.

In any event, the Java application may provide the user with categories or types of pets that are available from the Pet Shop (see display box 412) when the user so indicates (see user select box 414) on user interface 410 (i.e., screen of client system in use). If the user selects Mammals as shown in user select box 418, then a list of mammals that the Pet Shop carries may be displayed (see display box 416). After the user has selected cats from the list of mammals (see user select box 422), the different types of cats available from the Pet Shop will be displayed as shown in display box 420. If the user selects Persian (see user select box 424), an image of a Persian cat, as well as detailed information on Persian cats, may be displayed as shown in display box 426.

To provide the user with the information shown in each of the display boxes, embedded SQL statements in the Java application 402 may be used to fetch the data representing the information. The information displayed in display boxes 412, 416 and 420 may be provided in a relatively short time from the Pet Shop database 404. However, the information displayed in information box 426 may take a longer time since an image, which is data-intensive, is provided. Thus, to enhance user experience when browsing the Pet Shop Web site, the information in display box 426 may advantageously be pre-fetched from database 404 into a cache.

FIG. 4(b) depicts a conceptual view of an application program with data pre-fetching that may be used to access the Web site. FIG. 4(b) is identical to FIG. 4(a) except that when the user selects cats as the mammals in which the user is interested, the images and detailed information of all cats that the Pet Shop carries are pre-fetched into a cache (see box 428). Thus, when the user selects Persian as the type of cats in which the user is interested, the image and detailed information on Persian cats will be displayed in a relatively short time. Further, if the user were to be interested in a different type of cats, which is very likely to occur, the image and detailed information on that cat may also be provided to the user in a relatively short time.

To pre-fetch the images, as well as the detailed information on all cats in the database, an SQL mediator 430 is implemented. The SQL mediator 430 is a Java plug-in software module. To create the SQL mediator 430, a programmer may traverse through the application panels (the panels that are to be displayed in display boxes 412, 416, 420 and 426) with a developer tool to identify the SQL calls to fetch data from the database. Each identified SQL call may be selected to be part of the SQL mediator 430. In this case, only the calls from the panel representing display box 416 may be selected since only these SQL calls fetch data-intensive information. Thus, when the user selects cats from display box 416, the SQL mediator may pre-fetch images of all the cats that the Pet Shop carries into the cache.

In FIGS. 4(c), 4(d) and 4(e), the steps that may be used by a developer to implement the SQL mediator 430 of the present invention are displayed. Particularly in FIG. 4(c), it is shown a tool that a developer may use to implement the invention. The tool is a WebSphere Studio Application Developer (WSAD). WSAD is a product of International Business Machines, Inc. WSAD is a core application development environment for building and maintaining Java 2 Platform, Enterprise Edition (J2EE) and Web services applications. Built on Eclipse V2.1 innovations and written to J2EE specifications Application Developer, WSAD optimizes and simplifies J2EE application development with best practices, visual tools, templates and code generation.

Thus, using the visual tools available from WSAD, the developer may parse the Java application 402 for the SQL calls from panels 410, 412, 416 and 420 (see box 452). As the developer parses the Java application, the developer may identify and select the SQL calls as shown in box 440 of FIG. 4(d). This is facilitated by file menu 436. Specifically, all SQL calls may be displayed in the file menu 436. After the developer selects the pertinent SQL calls, which in this case would be the SQL calls to display images of the available cats as well as the detailed information on the cats, the SQL mediator module 430 may be created to pre-fetch and cache the SQL calls to fetch all images and information of cats carried by the Pet Shop as shown in display box 432 of FIG. 4(e).

Note that the SQL mediator module 430 will also be created to pre-fetch images and information on all dogs that the Pet Shop carries if the user selects dogs from the list of mammals 416. Likewise, the SQL mediator will pre-fetch images and information on all mice or rabbits if the user selects mice or rabbits, respectively, from the list of mammals 416.

If instead of mammals, the user selects fish from the categories of pets displayed in display box 412. Then, when the list of all the fish is displayed on display box 416, the SQL mediator 430 will pre-fetch images and detailed information on all fish carried by the Pet Shop. The same is true for the birds.

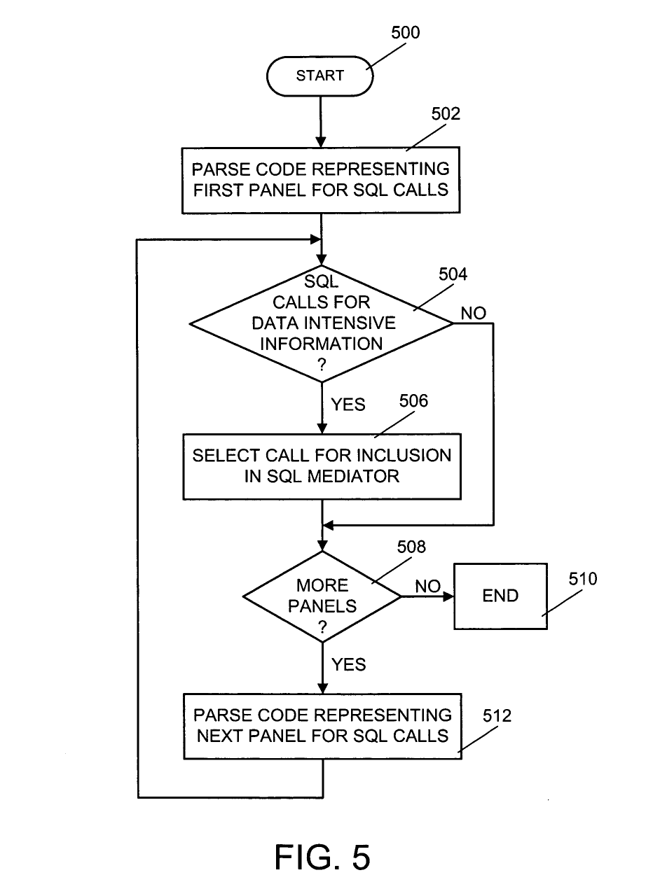

FIG. 5 is a flowchart of a process that may be used to create the SQL mediator 430. The process starts when the developer decides to implement the SQL mediator 430 (step 500). At that point, the developer may parse the code representing the first panel to be displayed for SQL calls. All SQL calls that are for data-intensive information may be selected by the developer for inclusion into the SQL mediator 430. Note that to identify an SQL call, the code may be parsed for a “SELECT” command, for example.

The next logical panel to be displayed from the previously parsed panel is then parsed for SQL calls. Again, all SQL calls that are for data-intensive information may be selected for inclusion in the SQL mediator 430. This process may continue until all possible panels in the application program are parsed before the process ends (steps 508, 512 and 510).

The SQL calls are entered in the SQL mediator 430 in their logical panel order. For example, SQL calls from the panel representing display box 420 (e.g., images and information on all cats) will be logically entered in the SQL mediator in an area corresponding to that panel.

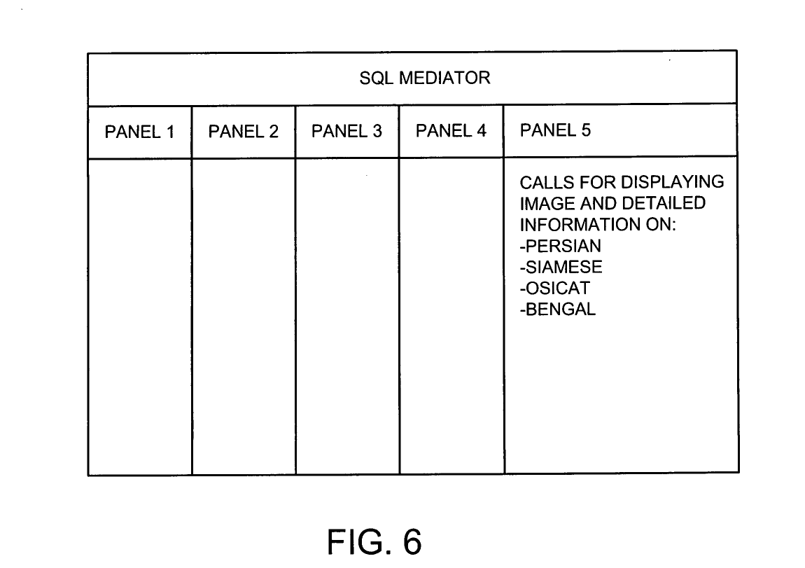

FIG. 6 depicts an exemplary table that may be used by the SQL mediator 430. In the table, only the panels for ultimately fetching images and detailed information on all cats are shown. However, it should be understood that the SQL mediator 430 may contain a table for each possible logical path a user may undertake to collect information on any pet that the Pet Shop carries. Alternatively, the SQL mediator may include one table in which sub-tables may be included. Each sub-table may correspond to a logical path. In any case, panels 1, 2, 3, 4 and 5 correspond to display boxes 410, 412, 416, 420 and 426, respectively. And, since only the SQL calls in panel 5 (i.e., display box 426) fetch data-intensive information, only the SQL calls from panel 5 need be entered in the table.

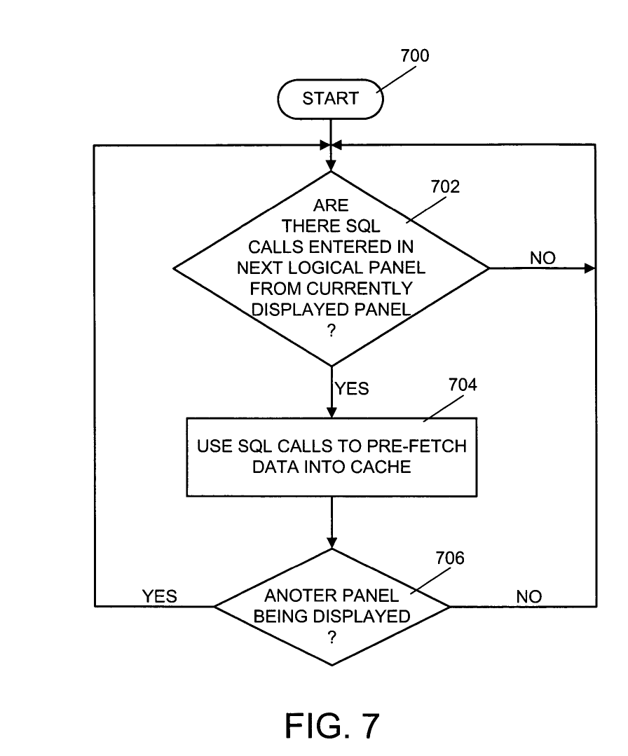

FIG. 7 is a flowchart of a process that may be used when a user is browsing the Web site. The process starts when the user accesses the Web site (e.g., the Pet Shop Web site). At that point, a display box (panel) with information will be displayed to the user. Once a panel is displayed, a check will be made (by the SQL mediator 430) to determine whether there are SQL calls entered in the successive panel in the SQL mediator 430 from the presently displayed panel. If so, the SQL calls in the panel in the SQL mediator table will be used to pre-fetch data into a cache. Note that, depending on implementation, the cache may be on either the client machine or on the server. Obviously, if the information is cached on the client machine, the information may be provided to the user faster than if it is cached on the server. However, there will be a lot more network traffic since all the data-intensive information, including data that the user may not use, will be pre-fetched and downloaded into the cache. In this particular embodiment, therefore, the information is cached on the server 110. The process ends when the user exits the Web site (steps 700-706).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of pre-fetching data comprising the steps of:
determining, when a first piece of information is being displayed, whether a second piece of information is data-intensive; and
pre-fetching the data representing the second piece of information if the second piece of information is data-intensive.

2. The method of claim 1 wherein data-intensive information is pre-fetched using a database query call entered in a log.

3. The method of claim 2 wherein the first piece of information being displayed includes a plurality of user selections and the data being pre-fetched includes data representing information to be displayed based on the plurality of user selections.

4. The method of claim 3 wherein if the user chooses a selection from the plurality of user selections, pre-fetched data representing data to be displayed based on the selection is displayed to the user.

5. A method of generating code to pre-fetch data comprising the steps of:
parsing an application program for database query calls, the application program including code for displaying information to a user in a number of succeeding panels;
identifying each database query call in each panel as a selectable or un-selectable query call, a selectable query call being a call to fetch data-intensive information and an un-selectable query call being a call to fetch non-data-intensive information; and
entering each selectable call in a respective panel in a table, the table being divided into the number of panels such that when a preceding panel is being displayed and selectable calls are in a succeeding panel in the table, data may be pre-fetched using the selectable calls in the succeeding panel.

6. A computer program product on a computer readable medium for pre-fetching data comprising:
code means for determining, when a first piece of information is being displayed, whether a second piece of information is data-intensive; and
code means for pre-fetching the data representing the second piece of information if the second piece of information is data-intensive.

7. The computer program product of claim 6 wherein data-intensive information is pre-fetched using a database query call entered in a log.

8. The computer program product of claim 7 wherein the first piece of information being displayed includes a plurality of user selections and the data being pre-fetched includes data representing information to be displayed based on the plurality of user selections.

9. The computer program product of claim 8 wherein if the user chooses a selection from the plurality of user selections, pre-fetched data representing data to be displayed based on the selection is displayed to the user.

10. A computer program product on a computer readable medium for enabling a user to generate code to pre-fetch data comprising:
code means for parsing an application program for database query calls, the application program including code for displaying information to a user in a number of succeeding panels;
code means for identifying each database query call in each panel as a selectable or un-selectable query call, a selectable query call being a call to fetch data-intensive information and an un-selectable query call being a call to fetch non-data-intensive information; and
code means for entering each selectable call in a respective panel in a table, the table being divided into the number of panels such that when a preceding panel is being displayed and selectable calls are in a succeeding panel in the table, data may be pre-fetched using the selectable calls in the succeeding panel.

11. An apparatus for pre-fetching data comprising:
means for determining, when a first piece of information is being displayed, whether a second piece of information is data-intensive; and
means for pre-fetching the data representing the second piece of information if the second piece of information is data-intensive.

12. The apparatus of claim 11 wherein data-intensive information is pre-fetched using a database query call entered in a log.

13. The apparatus of claim 12 wherein the first piece of information being displayed includes a plurality of user selections and the data being pre-fetched includes data representing information to be displayed based on the plurality of user selections.

14. The apparatus of claim 13 wherein if the user chooses a selection from the plurality of user selections, pre-fetched data representing data to be displayed based on the selection is displayed to the user.

15. An apparatus for generating code to pre-fetch data comprising:
means for parsing an application program for database query calls, the application program including code for displaying information to a user in a number of succeeding panels;
means for identifying each database query call in each panel as a selectable or un-selectable query call, a selectable query call being a call to fetch data-intensive information and an un-selectable query call being a call to fetch non-data-intensive information; and
means for entering each selectable call in a respective panel in a table, the table being divided into the number of panels such that when a preceding panel is being displayed and selectable calls are in a succeeding panel in the table, data may be pre-fetched using the selectable calls in the succeeding panel.

16. A system for pre-fetching data comprising:
at least one storage device for storing code data; and
at least one processor for processing the code data to determine, when a first piece of information is being displayed, whether a second piece of information is data-intensive, and to pre-fetch the data representing the second piece of information if the second piece of information is data-intensive.

17. The system of claim 16 wherein data-intensive information is pre-fetched using a database query call entered in a log.

18. The system of claim 17 wherein the first piece of information being displayed includes a plurality of user selections and the data being pre-fetched includes data representing information to be displayed based on the plurality of user selections.

19. The system of claim 18 wherein if the user chooses a selection from the plurality of user selections, pre-fetched data representing data to be displayed based on the selection is displayed to the user.

20. A system for generating code to pre-fetch data comprising:
at least one storage device for storing code data; and
at least one processor for processing the code data to parse an application program for database query calls, the application program including code for displaying information to a user in a number of succeeding panels, to identify each database query call in each panel as a selectable or un-selectable query call, a selectable query call being a call to fetch data-intensive information and an un-selectable query call being a call to fetch non-data-intensive information, and to enter each selectable call in a respective panel in a table, the table being divided into the number of panels such that when a preceding panel is being displayed and selectable calls are in a succeeding panel in the table, data may be pre-fetched using the selectable calls in the succeeding panel.
